(19) United States
(12) Patent Application Publication
(10) Pub. No.: US 2024/0424585 A1
(43) Pub. Date: Dec. 26, 2024

(54) METHOD FOR DESIGNING CYLINDRICAL SKIVING TOOL WITHOUT GEOMETRIC RELIEF ANGLE

(71) Applicant: JIANGSU UNIVERSITY, Zhenjiang (CN)

(72) Inventors: Erkuo GUO, Zhenjiang (CN); Chang LIU, Zhenjiang (CN); Mei YIN, Zhenjiang (CN); Jia XU, Zhenjiang (CN); Lele HU, Zhenjiang (CN)

(73) Assignee: JIANGSU UNIVERSITY, Zhenjiang (CN)

(21) Appl. No.: 18/563,404

(22) PCT Filed: Apr. 21, 2023
(86) PCT No.: PCT/CN2023/089713

§ 371 Date: Nov. 22, 2023

(30) Foreign Application Priority Data
Dec. 9, 2022 (CN) 202211580553.X

(51) Int. Cl. B23P 15/36; B23F 19/06

(52) U.S. Cl. CPC B23F 5/163; B23F 21/10; B23P 15/36; G06F 30/17; B23F 19/06

(57) ABSTRACT

A method for designing a cylindrical skiving tool without a geometric relief angle is provided. The method includes: designing a teeth number and a crossed shaft angle of a tool; calculating a barrel-shaped conjugate surface conjugated to a tooth surface of a to-be-machined gear; determining an offset of a rake face of the cylindrical skiving tool from a middle section of the barrel-shaped conjugate surface; designing a helix angle of the tool; designing a rake angle of the tool; calculating an edge profile of the rake face; obtaining design parameters and mounting parameters of the skiving tool; manufacturing the tool according to the design parameters of the tool, and performing skiving on a skiving machine according to the mounting parameters of the tool. The present disclosure provides a skiving method under a spatially-offset conjugate condition, to solve the problems of fast accuracy degradation and short service life.

### TECHNICAL FIELD

The present disclosure relates to the technical field of gear machining and gear machining tools, and in particular to a method for designing a cylindrical skiving tool without a geometric relief angle.

### BACKGROUND

The gear is a critical basic part in many industries, and its machining level is of great importance to development of high-accuracy gears. As a novel gear machining process, skiving can machine compact internal gears with a small undercut or without an undercut on high-accuracy harmonic reducers and automatic gearboxes, and has advantages of high accuracy, high efficiency, environmental protection, etc. The gear skiving has been used by more and more enterprises to replace the conventional gear hobbing/shaping/broaching as well as gear honing/grinding.

The gear skiving depends on design of a skiving tool. At present, the common skiving tool is a conical skiving tool. In order to avoid interference between a back face of the tool and a machined tooth surface, a geometric relief angle is provided on the back face of the conical skiving tool. The conical skiving tool is similar to a shaping tool. Due to the geometric relief angle, an outer diameter of the conical skiving tool is decreased constantly in resharpening to cause a change of an edge profile. Consequently, the edge profile of the tool and the tooth surface of the gear do not satisfy a conjugate relation, thereby shortening a service life of the tool and reducing an accuracy of the machined gear. An error-free edge profile of the conical skiving tool can be achieved in some methods. However, according to these methods, the back face of the skiving tool is a free-form surface, and thus the skiving tool is ground complicatedly and applied difficultly in fact. Therefore, how to overcome defects of increased tool profile errors after resharpening and short service life of the existing conical skiving tool is a key problem to be solved in gear skiving.

### SUMMARY

In view of defects in the prior art, the present disclosure provides a method for designing a cylindrical skiving tool without a geometric relief angle. The cylindrical skiving tool has a consistent accuracy after resharpening and a longer service life. With a form grinding, the cylindrical skiving tool is manufactured simply.

The present disclosure achieves the above technical objective through the following technical solutions.

A method for designing a cylindrical skiving tool without a geometric relief angle includes:
S1: designing a teeth number zₜ and a crossed shaft angle Σ of the cylindrical skiving tool according to parameters of a to-be-machined gear;
S2: designing an initial helix angle βᵣ₀ of the cylindrical skiving tool, and calculating a center distance a of the cylindrical skiving tool;
S3: calculating a barrel-shaped conjugate surface S⁽²⁾ conjugated to a tooth surface of the to-be-machined gear; determining whether the barrel-shaped conjugate surface S⁽²⁾ has surface intersection; if yes, going back to the step S1 to modify the teeth number or the crossed shaft angle of the cylindrical skiving tool; and if no, proceeding to step S4;
S4: determining an offset z_{off} of a rake face of the cylindrical skiving tool from a middle section of the barrel-shaped conjugate surface S⁽²⁾;
S5: designing a helix angle βₜ of the cylindrical skiving tool; determining whether interference exists between a back face of the cylindrical skiving tool and the tooth surface of the to-be-machined gear; if yes, going back to the step S4 to reduce the offset z_{off} of the rake face of the cylindrical skiving tool from the middle section of the barrel-shaped conjugate surface S⁽²⁾; and if no, calculating a width b of the cylindrical skiving tool under present parameters, and proceeding to step S6;
S6: determining whether working relief angles of main cutting-edges on both flanks of the cylindrical skiving tool are symmetrical; if no, going back to the step S5 to modify the helix angle βₜ of the cylindrical skiving tool; and if yes, proceeding to step S7;
S7: designing a rake angle γ₀ of the cylindrical skiving tool;
S8: constructing a rake plane according to the rake angle γ₀ of the cylindrical skiving tool, and calculating an edge profile of the rake face;
S9: obtaining design parameters and mounting parameters of the cylindrical skiving tool, the design parameters including the teeth number zₜ, the helix angle βₜ, the width b, and the rake angle γ₀, and the mounting parameters including the crossed shaft angle Σ, the center distance a, and the offset z_{off} of the rake face of the cylindrical skiving tool from the middle section of the barrel-shaped conjugate surface; and
S10: manufacturing the cylindrical skiving tool according to the design parameters of the cylindrical skiving tool in the step S9 and the edge profile of the rake face, and performing skiving on a skiving machine according to the mounting parameters of the cylindrical skiving tool.

Further, the crossed shaft angle Σ in the step S1 is selected as follows: when a helix angle β_{w} of the to-be-machined gear falls within a range of 15° to 30°, the crossed shaft angle Σ is the same as the helix angle β_{w} of the to-be-machined gear; and when the helix angle β_{w} of the to-be-machined gear does not fall within the range of 15° to 30°, the crossed shaft angle Σ is selected from the range of 15° to 30°.

Further, the initial helix angle βᵣ₀ of the cylindrical skiving tool in the step S2 is calculated by:

$${β}_{t 0} = \vert {β}_{w} - Σ \vert$$

where, βᵣ₀ is the initial helix angle of the cylindrical skiving tool, β_{w} is the helix angle of the to-be-machined gear, and Σ is the crossed shaft angle of the cylindrical skiving tool.

Further, the center distance a of the cylindrical skiving tool in the step S2 is calculated by:

$$a = {r}_{pw} - {r}_{pt}$$

where, r_{pw} is a pitch radius of the to-be-machined gear, rₚₜ is a pitch radius of the cylindrical skiving tool, and

$${r}_{pt} = \frac{{r}_{pw} {z}_{t} cos {β}_{w}}{{z}_{w} cos {β}_{t 0}} ,$$

being the teeth number of the cylindrical skiving tool, and z_{w} being a teeth number of the to-be-machined gear.

Further, the barrel-shaped conjugate surface in the step S3 is calculated by following two eqs.:

$$QM - {mn}_{M} = 0$$

where, QM is a segment from a meshing point M on the tooth surface to a point Q on the conjugate surface, n_{M} is a normal vector of the meshing point M on the tooth surface, and m is a proportionality constant; and

$$\{ \begin{matrix}{S}^{( 2 )} = {M}_{tw} {S}^{( 1 )} \\ {M}_{tw} = {M}_{t - 2} {M}_{2 - 1} {M}_{1 - w}\end{matrix}$$

where, S⁽²⁾ is the barrel-shaped conjugate surface, S⁽¹⁾ is a helicoid of the to-be-machined gear, M_{tw} is a coordinate transformation matrix, and Mₜ₋₂=Rot(k,φₜ)Tran(k,z_{off}), M₂₋₁=Rot(i,Σ)Tran(i,a), and M_{1-w}=Rot(k,φ_{w}), Rot(k,φₜ) representing a rotation matrix with a rotation angle φₜ around a tool z-axis, Tran(k,z_{off}) representing a translation matrix with a translation distance z_{off} along the tool z-axis, Rot(i,Σ) representing a rotation matrix with a rotation angle Σ around an x-axis of the to-be-machined gear, Tran(i,a) representing a translation matrix with a translation distance a along the x-axis of the to-be-machined gear, and Rot(k,φ_{w}) representing a rotation matrix with a rotation angle φ_{w} around a z-axis of the to-be-machined gear.

Further, the working relief angles αₑ of the main cutting-edges on both flanks of the cylindrical skiving tool in the step S6 each are expressed by an included angle between a normal vector on a meshing line for the barrel-shaped conjugate surface S⁽²⁾ and a normal vector on the contact line for the back face of the cylindrical skiving tool, and are calculated by:

$${α}_{e} = < {N}_{t} , {N}_{c} >$$

where, Nₜ is the normal vector on the meshing line for the barrel-shaped conjugate surface at a moment, and N_{c} is the normal vector on the meshing line for the back face of the cylindrical skiving tool.

Further, the rake angle of the cylindrical skiving tool in the step S7 falls within a range of 5° to 15°.

Further, the edge profile S_{γ} of the rake face of the cylindrical skiving tool in the step S8 is calculated by:

$${S}_{γ} = Tran ( i , {r}_{t} ) Tran ( k , {z}_{off} ) Rot ( i , {β}_{t} ) Rot ( j , - {γ}_{0} )$$

where, rₜ is a tool radius with the offset z_{off}, Tran(i,rₜ) represents a translation matrix with a translation distance rₜ along a tool x-axis, Tran(k,z_{off}) represents a translation matrix with a translation distance z_{off} along a tool z-axis, Rot(i,βₜ) represents a rotation matrix with a rotation angle βₜ around the tool x-axis, and Rot(j,−γ₀) represents a rotation matrix with a rotation angle-γ₀ around a tool y-axis.

The present disclosure has following advantages.

1) The cylindrical skiving tool without a geometric relief angle designed according to the design method of the present disclosure has a consistent accuracy after resharpening and a longer service life. Since the skiving tool is a cylindrical structure, only the rake face of the tool is ground in resharpening without changing the edge profile of the tool, and the edge profile of the tool is highly stable. In addition, the cylindrical skiving tool has a larger resharpening thickness and a longer service life than the conical skiving tool.

2) Compared with complicated generating grinding for the back face in manufacturing of the conical skiving tool, the cylindrical skiving tool without a geometric relief angle designed according to the design method of the present disclosure is structurally similar to a cylindrical gear, and can be machined by form grinding. This can simplify a tool manufacturing process, improve a tool manufacturing efficiency, and lower a tool manufacturing cost.

### BRIEF DESCRIPTION OF THE DRAWINGS

FIG. 1 is a flow chart of a method for designing a cylindrical skiving tool without a geometric relief angle according to an embodiment of the present disclosure.

FIG. 2 is a schematic view of a barrel-shaped conjugate surface conjugated to an internal gear according to an embodiment of the present disclosure.

FIG. 3 is a local view of a barrel-shaped conjugate surface according to an embodiment of the present disclosure.

FIG. 4 illustrates a change of working relief angles of main cutting-edges on both flanks of a tool according to an embodiment of the present disclosure.

FIG. 5 illustrates an intercepted edge profile of a rake face of a tool on a barrel-shaped conjugate surface according to an embodiment of the present disclosure.

FIG. 6 illustrates a projected edge profile for an edge profile of a rake face of a tool on an end surface according to an embodiment of the present disclosure.

FIG. 7 illustrates a cylindrical skiving tool without a geometric relief angle designed according to an embodiment of the present disclosure.

### DETAILED DESCRIPTION OF THE EMBODIMENTS

In order to make the objectives, technical solutions, and advantages of the embodiments of the present disclosure clearer, the technical solutions in the embodiments of the present disclosure will be clearly and completely described below in conjunction with the accompanying drawings in the embodiments of the present disclosure. Apparently, the described embodiments are some, rather than all of the embodiments of the present disclosure.

A helical internal gear with an involute tooth profile, a teeth number z_{w}=97, a module mₙ=1.5875 mm, a pressure angle αₙ=20°, a helix angle β_{w}=23.5° (right-handed rotation), a tip diameter dₐ₁=139.78 mm, a root diameter d_{f1}=147.82 mm, a cross-rod distance of 135.593 mm, and a rod diameter of 3.5 mm is used as a to-be-machined gear. The method for designing the cylindrical skiving tool without a geometric relief angle provided by the present disclosure is used to design a skiving tool for the helical internal gear with the involute tooth profile.

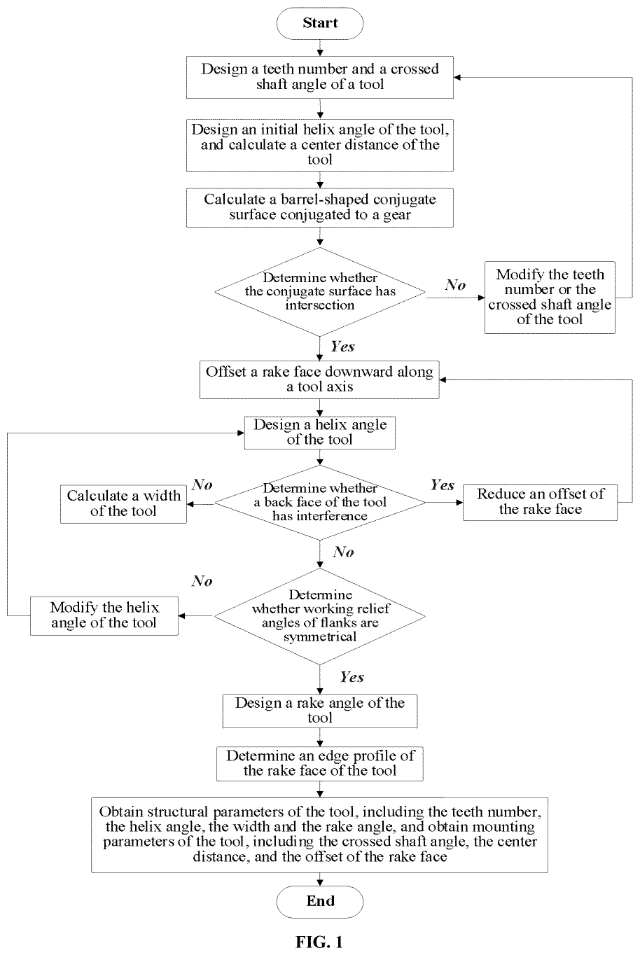

Referring to FIG. 1 to FIG. 6, the method for designing the cylindrical skiving tool without a geometric relief angle provided by the embodiment of the present disclosure specifically includes the following steps.

S1: A teeth number zₜ=37 and a crossed shaft angle Σ of the cylindrical skiving tool are designed according to parameters of a to-be-machined gear.

The crossed shaft angle Σ is selected as follows: When a helix angle β_{w} of the to-be-machined gear falls within a range of 15° to 30°, the crossed shaft angle Σ is the same as the helix angle β_{w} of the to-be-machined gear. When the helix angle β_{w} of the to-be-machined gear does not fall within the range of 15° to 30°, the crossed shaft angle Σ is selected from the range of 15° to 30°. Since the to-be-machined gear has a helix angle β_{w}=23.5°, and the helix angle falls within the range of 15° to 30°, the crossed shaft angle Σ=23.5°.

S2: An initial helix angle βᵣ₀ of the cylindrical skiving tool is designed, and a center distance a of the cylindrical skiving tool is calculated.

Since the helix angle β_{w} of the to-be-machined gear is the same as the crossed shaft angle Σ, the tool has the initial helix angle βᵣ₀=0° calculated by βᵣ₀=|β_{w}−Σ|. Meanwhile, under present parameters, the tool has the center distance a=36.006 mm calculated by a=r_{pw}−rₚₜ, where, r_{pw} is a pitch radius of the to-be-machined gear, rₚₜ is a pitch radius of the tool, and

$${r}_{pt} = \frac{{r}_{pw} {z}_{t} cos {β}_{t}}{{z}_{w} cos {β}_{t 0}} ,$$

zₜ being the teeth number of the tool, and z_{w} being a teeth number of the to-be-machined gear.

S3: A barrel-shaped conjugate surface S⁽²⁾ conjugated to a tooth surface of the to-be-machined gear is calculated. Whether the barrel-shaped conjugate surface S⁽²⁾ has surface intersection is determined. If yes, it is indicated that the barrel-shaped conjugate surface S⁽²⁾ calculated under the present parameters has a singular point, and there is a need to go back to the Step S1 to modify the teeth number or the crossed shaft angle of the tool, until the barrel-shaped conjugate surface S⁽²⁾ does not have the surface intersection. If no, Step S4 is proceeded.

The barrel-shaped conjugate surface S⁽²⁾ is calculated by Eqs. (1)-(8). FIG. 2 is a schematic view of a barrel-shaped conjugate surface conjugated to an internal gear. A fixed coordinate system O₁-x₁, y₁, z₁ of the to-be-machined gear and a fixed coordinate system O₂-x₂, y₂, z₂ of the tool are established. A z₁-axis coincides with a rotating shaft of the to-be-machined gear, a z₂-axis coincides with a rotating shaft of the tool, and an included between the z₁-axis and the z₂-axis is the crossed shaft angle Σ of the tool. An x₁-axis coincides with an x₂-axis. A minimum distance between the to-be-machined gear and the rotating shaft of the tool is the initial center distance a of the tool. The to-be-machined gear rotates around the z₁-axis at a uniform angular velocity ω^{(w)}, and the tool rotates around the z₂-axis at a uniform angular velocity ω^{(t)}. A point Q is located on a straight line l perpendicular to the x-axis and passing through a pitch circle r_{pw} in the fixed coordinate system of the gear, a point M is any point in a meshing state on the barrel-shaped conjugate surface, QM is a segment from the meshing point M to the point Q, and n_{M} represents a normal vector of the meshing point M.

According to Eq. (1), when a tooth surface of a workpiece and the barrel-shaped conjugate surface rotate to a meshing moment, the segment QM is parallel to the normal vector n_{M} of the meshing point M, and m represents a proportionality constant.

$$QM - {mn}_{M} = 0 \qquad ( 1 )$$

The segment QM is a difference between a segment O₁Q and a segment O₁M. In a skiving coordinate system, O₁Q and O₁M are respectively calculated by:

$$\begin{matrix}{O}_{1} Q = {x}_{q} i + {y}_{q} j + {z}_{q} k & ( 2 ) \\ {O}_{1} M = Rot ( k , {φ}_{w} ) ( Rot ( k , θ ) ( {x}_{0} ( u ) i + {y}_{0} ( u ) j ) + {p}_{w} θ k ) & ( 3 )\end{matrix}$$

where, Rot(k,φₓ) represents a rotation matrix with a rotation angle φ_{w} around a z-axis of the to-be-machined gear, and Rot(k,θ) represents a rotation matrix with a rotation angle θ around the z-axis of the to-be-machined gear.

According to Eq. (2) and Eq. (3), the segment QM can be expressed as:

$$QM = {O}_{1} M - {O}_{1} Q \qquad ( 4 )$$

When the meshing point M conjugates to the tooth surface, a normal vector of the meshing point can be obtained by rotating a normal vector n for the tooth surface of the to-be-machined gear around the rotating shaft of the gear. Hence, the normal vector n_{M} of the meshing point M is expressed as:

$${n}_{M} = Rot ( k , {φ}_{w} ) n \qquad ( 5 )$$

By substituting Eq. (4) and Eq. (5) into Eq. (1), the normal vector n_{M} of the meshing point M can be expressed as:

$$[ \begin{matrix}{x}_{0} ( u ) cos ( θ + {φ}_{w} ) - {y}_{0} ( u ) sin ( θ + {φ}_{w} ) - {r}_{pw} - {mp}_{w} [ \frac{δ {x}_{0}}{δ u} sin ( θ + {φ}_{w} ) + \frac{δ {y}_{0}}{δ u} cos ( θ + {φ}_{w} ) ] \\ {x}_{0} ( u ) sin ( θ + {φ}_{w} ) + {y}_{0} ( u ) cos ( θ + {φ}_{w} ) - {r}_{pw} τ - {mp}_{w} [ - \frac{δ {x}_{0}}{δ u} cos ( θ + {φ}_{w} ) + \frac{δ {y}_{0}}{δ u} sin ( θ + {φ}_{w} ) ] \\ {p}_{w} θ - \frac{a}{tan Σ} τ - m ( \frac{δ {x}_{0}}{δ u} {x}_{0} ( u ) + \frac{δ {y}_{0}}{δ u} {y}_{0} ( u ) )\end{matrix} ] = 0 \qquad ( 6 )$$

With three eqs. in Eq. (6), parameters τ and m in Eq. (6) are removed with an elimination method to obtain an eq. only containing a parameter (u, θ, φ_{w}):

$$f ( u , θ , {φ}_{w} ) = 0 \qquad ( 7 )$$

Substituting a known helix parameter (u, θ) of a to-be-machined gear surface S⁽¹⁾ into Eq. (7) can obtain a rotation angle φ_{w} of the meshing point M around an axis of the to-be-machined gear. Therefore, all meshing points satisfying a meshing condition on the tooth surface of the gear can be obtained. Through coordinate transformation of Eq. (8), the meshing points on the tooth surface of the gear are transformed from the coordinate system of the workpiece to the coordinate system of the tool to obtain the barrel-shaped conjugate surface S⁽²⁾, namely:

$$\{ \begin{matrix}{S}^{( 2 )} = {M}_{tw} {S}^{( 1 )} \\ {M}_{tw} = {M}_{t - 2} {M}_{2 - 1} {M}_{1 - w}\end{matrix} \qquad ( 8 )$$

where, S⁽²⁾ is the barrel-shaped conjugate surface, S⁽¹⁾ is a helicoid of the to-be-machined gear, M_{tw} is a coordinate transformation matrix, and Mₜ₋₂=Rot(k,φₜ)Tran(k,z_{off}), M₂₋₁=Rot(i,Σ)Tran(i,a), and M_{1-w}=Rot(k,φ_{w}), Rot(k,φₜ) representing a rotation matrix with a rotation angle φₜ around a tool z-axis, Tran(k,z_{off}) representing a translation matrix with a translation distance z_{off} along the tool z-axis, Rot(i,Σ) representing a rotation matrix with a rotation angle Σ around an x-axis of the to-be-machined gear, Tran(i,a) representing a translation matrix with a translation distance a along the x-axis of the to-be-machined gear, and Rot(k,φ_{w}) representing a rotation matrix with a rotation angle φ_{w} around a z-axis of the to-be-machined gear.

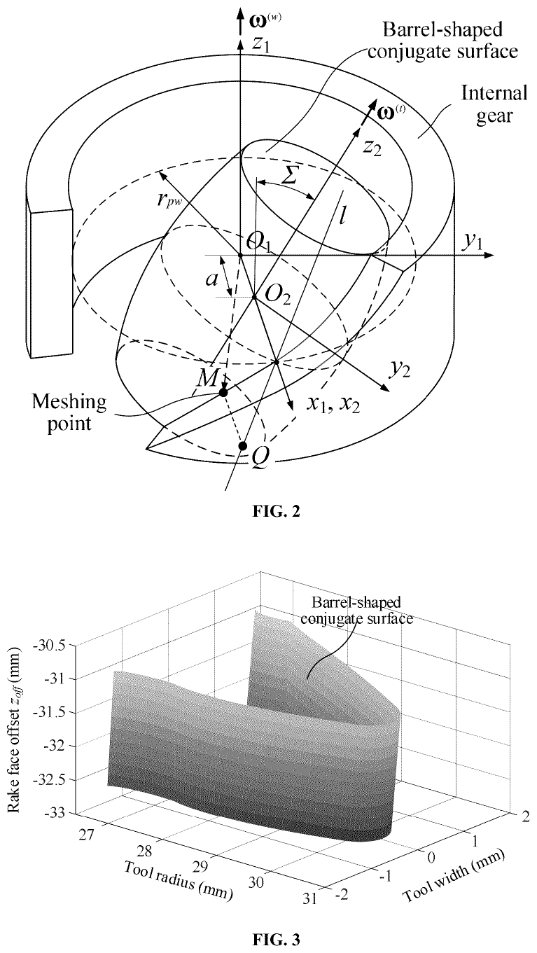

FIG. 3 is a local view of the calculated barrel-shaped conjugate surface. The calculated barrel-shaped conjugate surface S⁽²⁾ does not have the surface intersection, and Step S4 is proceeded.

S4: An offset z_{off}=−30 mm of a rake face of the cylindrical skiving tool from a middle section of the barrel-shaped conjugate surface S⁽²⁾ is determined.

S5: A helix angle βₜ of the cylindrical skiving tool is designed. Whether interference exists between a back face of the tool and the tooth surface of the to-be-machined gear is determined. If yes, there is a need to go back to the Step S4 to reduce the offset z_{off} of the rake face of the cylindrical skiving tool from the middle section of the barrel-shaped conjugate surface S⁽²⁾. If no, Step S6 is proceeded, and a width b of the tool under the present parameters is calculated.

In the embodiment, the tool has the initial helix angle βᵣ₀=0°. There is no interference between the back face of the tool and the tooth surface of the to-be-machined gear. The tool under the present parameters has the width b=40 mm.

S6: Whether working relief angles of main cutting-edges on both flanks of the tool are symmetrical is determined. If no, there is a need to go back to the Step S5 to modify the helix angle βₜ of the tool, until the working relief angles of the main cutting-edges on the both flanks of the tool are symmetrical. If yes, Step S7 is proceeded.

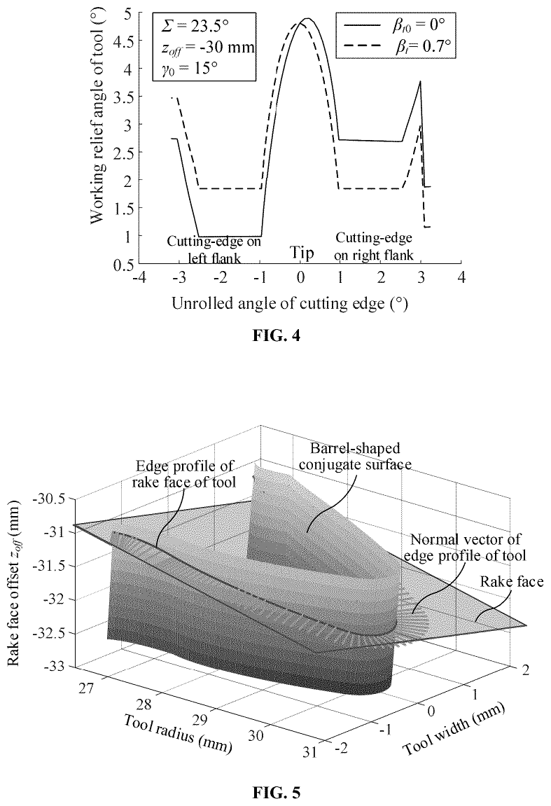

The working relief angles of the main cutting-edges on the both flanks of the tool are calculated by αₑ=<Nₜ, N_{c}>, where, Nₜ is a normal vector on the meshing line for the barrel-shaped conjugate surface at a moment, and N_{c} is a normal vector on the meshing line for the back face of the tool. With calculation, as shown in FIG. 4, when the tool has the initial helix angle βᵣ₀−0°, the crossed shaft angle Σ=23.5°, the rake angle γ₀=15°, and the offset z_{off}=−30 mm of the rake face of the cylindrical skiving tool from the middle section of the barrel-shaped conjugate surface, the working relief angle of the left flank is 1°, and the working relief angle of the right flank is 2.73°. In other words, the working relief angles of the flanks of the tool are asymmetrical. In cutting of the tool, the main cutting-edges on both flanks of the tool are worn unevenly to lower a service life of the tool. Hence, there is a need to go back to the Step S5 to modify the helix angle βₜ of the tool, until the working relief angles of the main cutting-edges on both flanks of the tool are symmetrical. The tool has the helix angle βₜ=0.7°, as shown in FIG. 4. In this case, the working relief angles of the main cutting-edges on both flanks of the tool are symmetrical. This makes the main cutting-edges on both flanks of the tool worn more evenly.

S7: A rake angle γ₀=15° of the cylindrical skiving tool is designed.

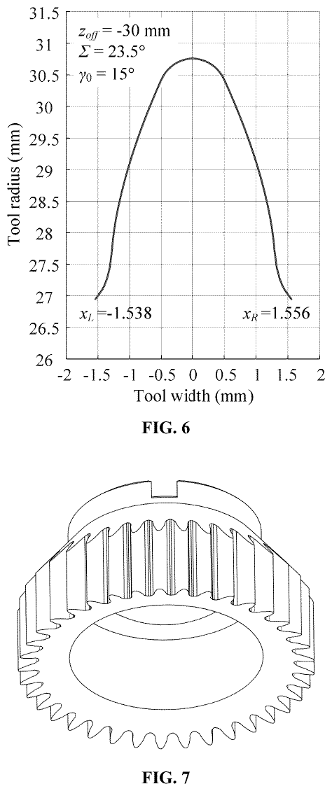

S8: According to the rake angle γ₀=15° of the cylindrical skiving tool, a rake plane is constructed, and an edge profile of the rake face is calculated by S_{γ}=Tran(i,rᵢ)Tran(k, Z_{off}) Rot(i,βₜ)Rot(j,−γ₀) where, z_{off} is a tool axial offset, rₜ is a tool radius with the offset z_{off}, βₜ is the helix angle of the tool, γ₀ is the rake angle of the tool, Tran(i,rₜ) represents a translation matrix with a translation distance rₜ along a tool x-axis, Tran(k,z_{off}) represents a translation matrix with a translation distance z_{off} along a tool z-axis, Rot(i,βₜ) represents a rotation matrix with a rotation angle βₜ around the tool x-axis, and Rot(j,−γ₀) represents a rotation matrix with a rotation angle −γ₀ around a tool y-axis. FIG. 5 illustrates an intercepted edge profile of a rake face of a tool on a barrel-shaped conjugate surface according to the calculation eq. of the rake face. FIG. 6 illustrates a projected edge profile for an edge profile of a rake face of a tool on an end surface.

S9: Design parameters and mounting parameters of the cylindrical skiving tool are obtained. The design parameters include the teeth number zₜ=37, the helix angle βₜ=0.7°, the width b=40 mm, and the rake angle γ₀=15°. The mounting parameters include the crossed shaft angle Σ=23.5°, the center distance a=36.01 mm, and the offset z_{off}=−30 mm of the rake face of the cylindrical skiving tool from the middle section of the barrel-shaped conjugate surface.

S10: The cylindrical skiving tool is manufactured according to the design parameters of the tool in the Step S9 and the edge profile of the rake face. Skiving is performed on a skiving machine according to the mounting parameters of the tool in the Step S9.

Compared with complicated generating grinding for the back face in manufacturing of the conical skiving tool, the cylindrical skiving tool of the present disclosure is structurally similar to a cylindrical gear, and can be machined by form grinding. This can simplify a tool manufacturing process, improve a tool manufacturing efficiency, and lower a tool manufacturing cost.

When the cylindrical skiving tool designed with the method of the present disclosure is used, since the skiving tool is a cylindrical structure, only the rake face of the tool is ground in resharpening without changing the edge profile of the tool, and the edge profile of the tool is highly stable. In addition, the cylindrical skiving tool has a larger resharpening thickness and a longer service life than the conical skiving tool.

The above embodiments merely represent several embodiments of the present disclosure, and the descriptions thereof are specific and detailed, but they should not be construed as limiting the patent scope of the present disclosure. It should be noted that those of ordinary skill in the art can further make several variations and improvements without departing from the concept of the present disclosure, and all of these fall within the protection scope of the present disclosure. Therefore, the protection scope of the present disclosure shall be subject to the protection scope defined by the claims.

What is claimed is:

1. A method for designing a cylindrical skiving tool without a geometric relief angle, comprising:
S1: designing a teeth number zₜ and a crossed shaft angle Σ of the cylindrical skiving tool according to parameters of a to-be-machined gear;
S2: designing an initial helix angle βᵣ₀ of the cylindrical skiving tool, and calculating a center distance a of the cylindrical skiving tool;
S3: calculating a barrel-shaped conjugate surface S⁽²⁾ conjugated to a tooth surface of the to-be-machined gear; determining whether the barrel-shaped conjugate surface S⁽²⁾ has surface intersection; if yes, going back to the step S1 to modify the teeth number or the crossed shaft angle of the cylindrical skiving tool; and if no, proceeding to step S4;
S4: determining an offset z_{off} of a rake face of the cylindrical skiving tool from a middle section of the barrel-shaped conjugate surface S⁽²⁾;
S5: designing a helix angle βₜ of the cylindrical skiving tool; determining whether interference exists between a back face of the cylindrical skiving tool and the tooth surface of the to-be-machined gear; if yes, going back to the step S4 to reduce the offset z_{off} of the rake face of the cylindrical skiving tool from the middle section of the barrel-shaped conjugate surface S⁽²⁾; and if no, calculating a width b of the cylindrical skiving tool under present parameters, and proceeding to step S6;
S6: determining whether working relief angles of main cutting-edges on both flanks of the cylindrical skiving tool are symmetrical; if no, going back to the step S5 to modify the helix angle βₜ of the cylindrical skiving tool; and if yes, proceeding to step S7;
S7: designing a rake angle γ₀ of the cylindrical skiving tool;
S8: constructing a rake plane according to the rake angle γ₀ of the cylindrical skiving tool, and calculating an edge profile of the rake face;
S9: obtaining design parameters and mounting parameters of the cylindrical skiving tool, the design parameters comprising the teeth number zₜ, the helix angle βₜ, the width b, and the rake angle γ₀, and the mounting parameters comprising the crossed shaft angle Σ, the center distance a, and the offset z_{off} of the rake face of the cylindrical skiving tool from the middle section of the barrel-shaped conjugate surface; and
S10: manufacturing the cylindrical skiving tool according to the design parameters of the cylindrical skiving tool in the step S9 and the edge profile of the rake face, and performing skiving on a skiving machine according to the mounting parameters of the cylindrical skiving tool.

2. The method for designing the cylindrical skiving tool without the geometric relief angle according to claim 1, wherein the crossed shaft angle Σ in the step S1 is selected as follows: when a helix angle β_{w} of the to-be-machined gear falls within a range of 15° to 30°, the crossed shaft angle Σ is the same as the helix angle β_{w} of the to-be-machined gear; and when the helix angle β_{w} of the to-be-machined gear does not fall within the range of 15° to 30°, the crossed shaft angle Σ is selected from the range of 15° to 30°.

3. The method for designing the cylindrical skiving tool without the geometric relief angle according to claim 1, wherein the initial helix angle βᵣ₀ of the cylindrical skiving tool in the step S2 is calculated by:
$${β}_{t 0} = \vert {β}_{w} - Σ \vert$$
wherein, βᵣ₀ is the initial helix angle of the cylindrical skiving tool, β_{w} is the helix angle of the to-be-machined gear, and Σ is the crossed shaft angle of the cylindrical skiving tool.

4. The method for designing the cylindrical skiving tool without the geometric relief angle according to claim 1, wherein the center distance a of the cylindrical skiving tool in the step S2 is calculated by:
$$a = {r}_{pw} - {r}_{pt}$$
wherein, r_{pw} is a pitch radius of the to-be-machined gear, rₚₜ is a pitch radius of the cylindrical skiving tool, and
$${r}_{pt} = \frac{{r}_{pw} {z}_{t} cos {β}_{t}}{{z}_{w} cos {β}_{t 0}} ,$$
zₜ being the teeth number of the cylindrical skiving tool, and z_{w} being a teeth number of the to-be-machined gear.

5. The method for designing the cylindrical skiving tool without the geometric relief angle according to claim 1, wherein the barrel-shaped conjugate surface in the step S3 is calculated by following two eqs.:
$$QM - {mn}_{M} = 0$$
wherein, QM is a segment from a meshing point M on the tooth surface to a point Q on the conjugate surface, n_{M} is a normal vector of the meshing point M on the tooth surface, and m is a proportionality constant; and
$$\{ \begin{matrix}{S}^{( 2 )} = {M}_{tw} {S}^{( 1 )} \\ {M}_{tw} = {M}_{t - 2} {M}_{2 - 1} {M}_{1 - w}\end{matrix}$$
wherein, S⁽²⁾ is the barrel-shaped conjugate surface, S⁽¹⁾ is a helicoid of the to-be-machined gear, M_{tw} is a coordinate transformation matrix, and Mₜ₋₂=Rot(k,φₜ)Tran(k,z_{off}), M₂₋₁=Rot(i,Σ)Tran(i,a), and M_{1-w}=Rot(k,φ_{w}), Rot(k,φₜ) representing a rotation matrix with a rotation angle φₜ around a tool z-axis, Tran(k,z_{off}) representing a translation matrix with a translation distance z_{off} along the tool z-axis, Rot(i,Σ) representing a rotation matrix with a rotation angle Σ around an x-axis of the to-be-machined gear, Tran(i,a) representing a translation matrix with a translation distance a along the x-axis of the to-be-machined gear, and Rot(k,φ_{w}) representing a rotation matrix with a rotation angle φ_{w} around a z-axis of the to-be-machined gear.

6. The method for designing the cylindrical skiving tool without the geometric relief angle according to claim 1, wherein the working relief angles αₑ of the main cutting-edges on both flanks of the cylindrical skiving tool in the step S6 each are expressed by an included angle between a normal vector on a meshing line for the barrel-shaped conjugate surface S⁽²⁾ and a normal vector on the contact line for the back face of the cylindrical skiving tool, and are calculated by:
$${α}_{e} = < {N}_{t} , {N}_{c} >$$
wherein, Nₜ is the normal vector on the meshing line for the barrel-shaped conjugate surface at a moment, and N_{c} is the normal vector on the meshing line for the back face of the cylindrical skiving tool.

7. The method for designing the cylindrical skiving tool without the geometric relief angle according to claim 1, wherein the rake angle of the cylindrical skiving tool in the step S7 falls within a range of 5° to 15°.

8. The method for designing the cylindrical skiving tool without the geometric relief angle according to claim 1, wherein the edge profile S_{γ} of the rake face of the cylindrical skiving tool in the step S8 is calculated by:
$${S}_{γ} = Tran ( i , {r}_{t} ) Tran ( k , {z}_{off} ) Rot ( i , {β}_{t} ) Rot ( j , - {γ}_{0} )$$
wherein, rₜ is a tool radius with the offset z_{off}, Tran(i,rₜ) represents a translation matrix with a translation distance rₜ along a tool x-axis, Tran(k,z_{off}) represents a translation matrix with a translation distance z_{off} along a tool z-axis, Rot(i,βₜ) represents a rotation matrix with a rotation angle βₜ around the tool x-axis, and Rot(j,−γ₀) represents a rotation matrix with a rotation angle −γ₀ around a tool y-axis.
